(19) United States
(12) Patent Application Publication
(10) Pub. No.: US 2015/0294362 A1
(43) Pub. Date: Oct. 15, 2015

(54) Systems and Methods for Managing Account Information

(71) Applicant: FIRST DATA CORPORATION, Greenwood Village, CO (US)

(72) Inventors: Vijay Kumar Royyuru, Norristown, PA (US); Brent Dewayne Adkisson, Omaha, NE (US); Matthew Adler Borenstein, Atlanta, GA (US); Daniel Wilson Carnes, Bellevue, NE (US); Stephan Bernhard Wessels, Omaha, NE (US)

(21) Appl. No.: 14/687,439

(22) Filed: Apr. 15, 2015

Related U.S. Application Data
(60) Provisional application No. 61/979,910, filed on Apr. 15, 2014.

(51) Int. Cl. G06Q 30/02; H04W 4/02; H04W 12/06

(52) U.S. Cl. CPC G06Q 30/0261; H04W 12/06; H04W 4/02

(57) ABSTRACT

Systems and methods for managing account information can be provided by embodiments of the disclosure. In one embodiment, a consumer device may determine location information associated with the consumer device. The consumer device may determine, based at least in part on the location information, that the consumer device is located within a predetermined proximity to a merchant store location of a merchant. The consumer device may cause to send, a request to access the merchant device associated with the merchant. The consumer device may identify information associated with the merchant. The consumer device may determine, based at least in part on the account information, one or more consumer preferences associated with the merchant. The consumer device may access the merchant device based at least in part on the one or more consumer preferences.

### CROSS-REFERENCE TO RELATED APPLICATIONS

This application claims priority to U.S. Provisional Patent Application No. 61/979,910, entitled “Systems And Methods For Managing Account Information,” filed on Apr. 15, 2014, which is incorporated here by reference in its entirety.

### FIELD OF THE DISCLOSURE

The disclosure generally relates to electronic commerce, and in particular, relates to systems and methods for managing account information.

### BACKGROUND

When contemplating a mobile commerce transaction via a mobile phone or other computing device, consumers may have information for multiple accounts associated with multiple merchants. Due to the quantity of account information and merchants and certain conventional technologies available for using account information, it may be difficult for consumers and merchants to manage and keep track of various information associated with such account information when transacting commerce via a mobile phone or other computing device.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example system for managing account information in accordance with one or more example embodiments.

FIG. 2 illustrates a data flow diagram for managing account information in accordance with one or more example embodiments.

FIG. 3 illustrates a data flow diagram for managing account information in accordance with one or more example embodiments.

FIG. 4 illustrates a flow diagram of another example method for managing account information in accordance with one or more example embodiments.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like, but not necessarily the same or identical, elements throughout. Hence, if a feature is used across several drawings, the number used to identify the feature in the drawing where the feature first appeared will be used in later drawings.

### DETAILED DESCRIPTION

### Overview

Described herein are systems and methods for managing account information between a consumer operating a consumer device and a merchant having a merchant device and a merchant store. Broadly, certain embodiments of the systems and methods described herein may facilitate the access of account information in response to determining that a consumer device is within a predefined proximity to the merchant store location.

One or more embodiments may facilitate initiation of consumer interaction with the merchant. For example, a consumer device may check-in with a merchant device at a merchant location or remotely. Checking in may include one or more actions such as establishing a connection with the merchant device, receiving data from the merchant device, accessing the merchant device, and/or allowing the merchant device to access consumer data and/or the consumer device. Checking in may also result in exchanging merchant data with the consumer device. For example, the merchant data may contain details of how the merchant wants further interaction and how a check-out process may be completed. The consumer device and the merchant device may be any device capable of communicating wirelessly or through a wired connection.

In some embodiments, the consumer device may communicate with the merchant device and/or one or more service providers, in-store or remotely, over one or more wireless communication channels, before, during, and after payment and value added services. A service provider may be associated with a built-in service on the merchant device and/or a third-party service available by accessing one or more service provider servers. For example, a service provider may interact with the consumer device to provide the consumer device with service such as authentication, verification or access to merchant data and/or the merchant device through a network. The service provider may interact with the merchant device in order to establish a connection with the consumer device between the merchant device and the consumer device. The service provider may also provide the consumer device with merchant data that may determine how the merchant requires further interaction with the consumer device. It is understood that the above are only examples of functions that a service provider may provide a consumer device and/or a merchant device.

In one embodiment, the consumer identity may be received by the merchant and/or the service provider through the check-in process. The merchant and/or the service provider may coordinate other services with other service providers, including providing the check-in identity with other service providers, retrieving additional data, and facilitating the interaction between the consumer and those other services providers, either automatically or with consumer notification or confirmation.

In another embodiment, the communication between the consumer device and the merchant device during the check-in process may occur in a secured fashion, for example, using a secret key that is shared between the consumer device, the merchant device and/or a service provider server in order to decrypt data that has been encrypted for transmission between these devices. For example, the shared secret key may be intended for a service provider behind the merchant system such that the encrypted data is passed through the merchant system and is only decrypted, e.g., using the shared secret key, when it reaches the service provider server through the merchant device and/or other intermediaries such as payment systems or networks.

Certain embodiments of the systems and methods described herein may further facilitate the association of consumer purchase transactions with loyalty account information. For example, a consumer device may communicate with a merchant device, where data is exchanged between the consumer device and the merchant device during consumer transactions. These transactions may trigger a variety of value added services such as, but not limited to, offers, coupons, loyalty deals, etc. Accordingly, the merchant device may evaluate certain conditions such as a consumer profile, preferences, and/or promotions that may be associated with such value added services.

In one or more embodiments, a check-in process (e.g., with a merchant device) may be automated without the consumer taking a specific action. For example, consumer preferences may dictate whether a check-in may occur based on certain conditions. Some of these conditions may include being within the perimeters of geo-fencing and micro location based on wireless technologies, such as Wi-Fi and Bluetooth™, etc. It is understood that geo-fencing is a virtual perimeter or barrier for real-world geographic area, as in a radius around the store or point location or it may be a predefined set of boundaries like a neighborhood boundary. It is also understood that a micro location is associated with systems such as indoor positioning system, which may be a solution to locate objects or people inside a building using radio waves, magnetic fields, acoustic signals, or other sensory information collected by a mobile device. If one or more of the above conditions occur, the automated check-in event may cause, for example, an application on a consumer device to “wake up” and perform check-in with the merchant device. When the application, wakes up, it may exchange data with the merchant device and/or service provider in order to establish a connection with the merchant device. After the check in process, one or more transactions may occur. For example, a consumer may place an order with the merchant and may receive a receipt for completing the transaction. Additionally/alternatively the consumer may receive one or more value added services such as offers, coupons, etc.

In one or more embodiments, one or more post check-in events and transactions may be implemented between a consumer device, a merchant device, and/or a service provider. For example, a post check-in event may be where the merchant device may have identified the consumer and then honoring the consumer's subscriptions or preferences for notification of various offers provided by the merchant. In one example, a consumer may wish to be notified when a certain item is on sale or listed below a certain dollar amount.

In one or more embodiments, the check-in event may also flow in an opposite direction. For example, in the case when the merchant device performs a check-in process with the consumer device. This may be used for reverse delivery and authentication of the check-in identity, and confirming merchant identity to the consumer. For example, a pizza delivery driver using a merchant device may check-in in the opposite direction for delivery and receipt of payment. Such opposite check-in need not always result in receipt of payment, it may simply lead to delivery of other services, such as, promotions, notifications, deals, etc. In one or more embodiments, an example of a post check-in event may be a check-out event, which may be initiated from the consumer device and/or the merchant device. Further, the check-out event may be triggered based on other events or may be manually invoked by the consumer or the merchant. One example of a check-out event may be the consumer receiving a receipt for completion of a purchase transaction for goods or services.

According to one or more embodiments of the disclosure, a method is provided for managing account information. The method may include determining one or more processors, location information associated with the consumer device. The method may also include determining, based at least in part on the location information, that the consumer device is located within a predetermined proximity to a merchant store location of a merchant. Furthermore, the method may include transmitting, to a service provider server, a request to log in to a service provider of the service provider server. Additionally, the method may include receiving, from the service provider server, account information associated with a consumer account with the merchant. The method may also include determining, based at least in part on the account information, one or more consumer preferences associated with the merchant.

According to one or more other embodiments of the disclosure, a system is provided for managing account information. The system may include at least one memory for storing data and computer-executable instructions. The system may also include at least one processor to access the at least one memory and to execute the computer-executable instructions. The at least one processor may be configured to execute the instructions to receive, from a consumer device, a request to log in to a consumer application, the request comprising a merchant identifier associated with a merchant and a consumer identifier associated with the consumer device. The at least one processor may also be configured to execute the instructions to determine, based at least in part on the merchant identifier and consumer identifier, account information associated with a consumer account with the merchant. The at least one processor may further be configured to execute the instructions to determine, based at least in part on the account information, one or more consumer preferences associated with the merchant. Additionally, the at least one processor may further be configured to execute the instructions to transmit, to the consumer device, at least one of the account information or the one or more consumer preferences.

According to one or more other embodiments of the disclosure, a non-transitory computer-readable medium is provided. The computer-readable medium may store computer-executable instructions, that when executed by at least one processor, causes the at least one processor to receive, from a consumer device, a request to log in to a consumer application, the request comprising a merchant identifier associated with a merchant and a consumer identifier associated with the consumer device. The computer-readable medium may store further instructions that cause the at least one processor to determine, based at least in part on the merchant identifier and consumer identifier, account information associated with a consumer account with the merchant. Furthermore, the computer-readable medium may store instructions that cause the at least one processor to determine, based at least in part on the account information, one or more consumer preferences associated with the merchant. The computer-readable medium may also store instructions that cause the at least one processor to transmit, to the consumer device, at least one of the account information or the one or more consumer preferences.

One or more technical solutions can be achieved by certain embodiments of the disclosure. For example, in at least one embodiment, merchant identification and consumer identification can be communicated to a consumer account associated with the consumer. Based at least in part on the merchant identification, consumer transaction information and/or loyalty account information, an offer, advertising, and/or a discount can be transmitted to a consumer's mobile device and/or merchant point-of-sale device during the purchase transaction at the merchant location. Increased merchant revenue and/or consumer loyalty can result.

These and other embodiments of the disclosure will be described in more detail through reference to the accompanying drawings in the detailed description of the disclosure that follows. This brief introduction, including section titles and corresponding summaries, is provided for the reader's convenience and is not intended to limit the scope of the claims or the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Illustrative Embodiments

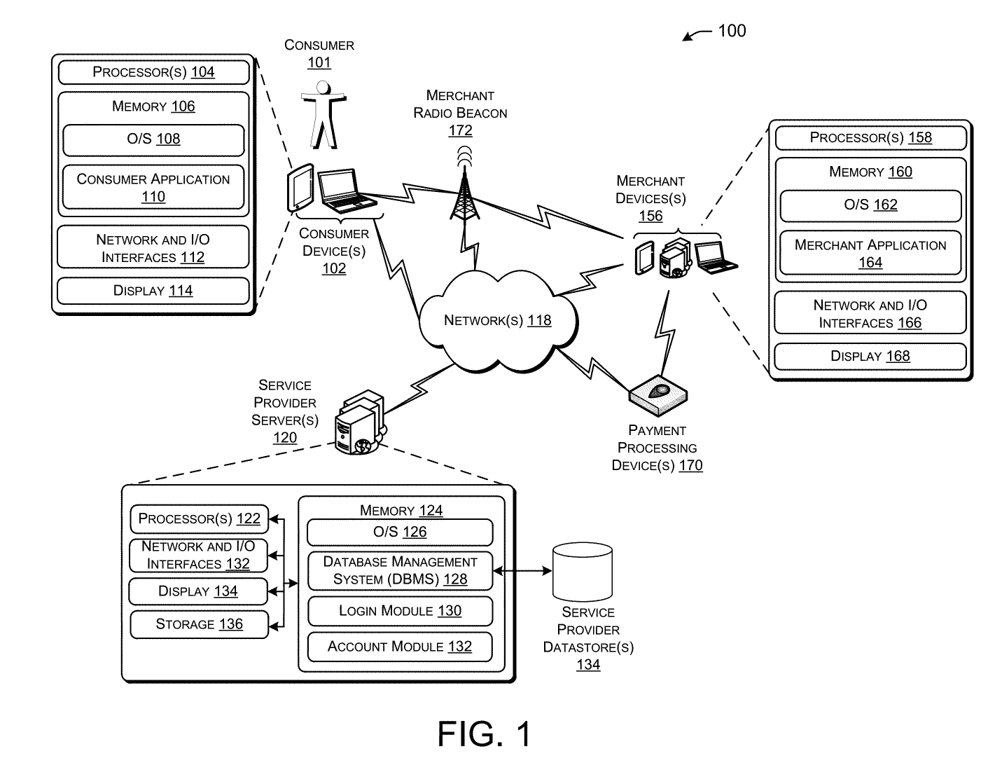

With reference now to FIG. 1, an example system 100 for managing account information is shown according to one or more embodiments of the disclosure. The system 100 may include one or more consumer devices 102 associated with a consumer, such as 101. The consumer device(s) 102 may be in communication, via one or more networks 118, with one or more service provider servers 120, one or more merchant devices 156, one or more payment processing devices 170, and/or one or more merchant radio beacons 172.

In general, the consumer device 102 may refer to any type of electronic device, and, more particularly, may refer to one or more of the following: a wireless communication device, a portable electronic device, a telephone (e.g., cellular phone, smart phone), a computer (e.g., laptop computer, tablet computer), a wearable computer device, a portable media player, a personal digital assistant (PDA), a vehicle infotainment system, and/or any other electronic device having a networked capability. The consumer device(s) 102 may include one or more computer processors 104, and a memory 106 storing an operating system (O/S) 108 and a consumer application 110. In addition, the consumer device(s) 102 may include one or more network and I/O interfaces 112, and a display 114. In certain embodiments, the consumer device(s) 102 may include one or more sensors capable of gathering information associated with a present environment of the consumer device(s) 102, or similar hardware devices, such as a camera, microphone, antenna, a gesture capture or detection device, or Global Positioning Satellite (GPS) device.

The computer processors 104 may comprise one or more cores and may be configured to access and execute (at least in part) computer-readable instructions stored in the memory 106. The one or more computer processors 104 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The consumer device 102 may also include a chipset (not shown) for controlling communications between the one or more processors 104 and one or more of the other components of the consumer device 102. In certain embodiments, the consumer device 102 may be based on an Intel® architecture or an ARM® architecture, and the processor(s) and chipset may be from a family of Intel® processors and chipsets. The one or more processors 104 may also include one or more application-specific integrated circuits (ASICs) or application-specific standard products (ASSPs) for handling specific data processing functions or tasks.

The memory 106 may include one or more computer-readable storage media (CRSM). In some embodiments, the memory 106 may include non-transitory media such as random access memory (RAM), flash RAM, magnetic media, optical media, solid state media, and so forth. The memory 106 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 106 may store an operating system 108 that includes a plurality of computer-executable instructions that may be implemented by the computer processor to perform a variety of tasks to operate the interface(s) and any other hardware installed on the consumer device 102. The memory 106 may also store content that may be displayed by the consumer device 102 or transferred to other devices (e.g., headphones) to be displayed or played by the other devices. The memory 106 may also store content received from the other devices. The content from the other devices may be displayed, played, or used by the consumer device 102 to perform any necessary tasks or operations that may be implemented by the computer processor or other components in the consumer device 102.

The memory 106 may also include an operating system (0/S) 108, which may provide an interface between other application software executing on the consumer device 102 and hardware resources of the consumer device 102. More specifically, the operating system 108 may include a set of computer-executable instructions for managing hardware resources of the consumer device 102 and for providing common services to other application programs (e.g., managing memory allocation among various application programs). The operating system 108 may include any operating system now known or which may be developed in the future including, but not limited to, any consumer operating system, any server operating system, any mainframe operating system, or any other proprietary or freely available operating system.

The memory 106 may also include a consumer application 110, which may be configured to perform various operations that may facilitate check-in and/or check-out events. For example, consumer application 110 may facilitate login and/or logout operations for the consumer 101 while accessing a merchant device 156 and/or service provider servers 120.

In certain embodiments, the consumer application 110 may determine that consumer device 102 is located within a predetermined or predefined proximity to a merchant store location of a merchant. For instance, the consumer application 110 may receive a signal from a merchant radio beacon 172 associated with the merchant store location. Such a signal may indicate that consumer device 102 is within the predetermined or predefined proximity. In other embodiments, the consumer application 110 may determine GPS location information of the consumer device 102 and compare it to GPS location information associated with the merchant store location. Based on this comparison, the consumer application 110 may determine that the consumer device 102 is within the predetermined or predefined proximity. In yet other embodiments, the consumer 101 may use the consumer device 102 to scan optical machine-readable data associated with the merchant store location, such as a barcode, quick response code, and/or the like. In other embodiments, the consumer application 1210 may receive acoustic signals from a merchant beacon in order to determine that the consumer device 102 is located within the predetermined proximity to the merchant store location. In some examples, geo-fencing and micro location technologies may be employed to utilize boundaries in order to determine the location of the consumer device 102 and perform certain actions. If the consumer device 102 is located within a certain proximity to a merchant store location. It is understood that geo-fencing and micro location technologies are technologies used to locate an object (e.g., consumer device 102) to determine geographic area, such as a radius around the store or a predefined area.

Upon determining that that the consumer device 102 is within the predetermined or predefined proximity to the merchant store location, the consumer application 110 may perform check-in, either manually or automatically. For example, the consumer application 110 may transmit a login request to a merchant device 156 and/or a service provider server 120. Such a request may be manual, for example, when a consumer 101 interacts with the consumer device (e.g., pressing a button, entering information, running an application, etc.), or may be automatic such that no user interaction is necessary. A login request may be granted based at least in part on whether one or more login credentials (e.g., consumer identifier, merchant identifier, username, password, etc.) have been confirmed and accepted. The consumer application 110 may be configured to access account information associated with a consumer account that the consumer 101 may have with the merchant. Such account information may include, but is not limited to, loyalty account information, order history information, notification information, receipt information, advertisement information, payment information, product offer information, and/or any other types of account information the consumer may have with the merchant.

According to other embodiments, the systems and methods described herein may enable certain automated services to be provided to the consumer device(s) 102. For instance, the consumer application 110 may be configured to automatically detect location information associated with the consumer device 102 and to provide personalized services to the consumer 101 based on the location information. For example, the consumer application 110 may determine that the consumer 101 has been located in an electronics department of a merchant store for a predetermined amount of time. In response, the consumer application 110 may be configured to display appropriate product information associated with products in the electronics department.

In other implementations, the automated services may include automatically communicating certain consumer information to the merchant device(s) 156 (e.g., via the service provider server(s) 120). For instance, based on a determination that the consumer device 102 is located within a predefined proximity to a merchant store location, the consumer application 110 may be configured to transmit certain consumer preferences and/or notifications to the merchant device(s) 156 associated with the merchant store location. For example, a hair salon merchant may be instructed, by the consumer application 110, to prepare certain staging materials at a particular station for the consumer 101. As another example, a restaurant merchant may be instructed to ready or assemble a carryout order. As yet another example, assembly of any type of order for any type of merchant may be initiated upon determination that the consumer 101 and/or consumer device 102 is located with the predetermined proximity to the merchant store location. For example, preparing or assembling a carryout order at a restaurant for delivery at drive-through or curbside, or assembly of order for pickup a grocery or pharmacy drive-through. It is understood that the above are only examples of services and that other examples may be envisioned.

In one or more embodiments, the consumer application 110 may interact with the merchant devices 156 and/or service providers 120. For example, when data is exchanged between the consumer device 102 and based on the consumer account information, the merchant device 156 may present the consumer device with one or more value added services such as, promotions, product offers, notifications, and loyalty offers. It is understood that the above are only examples of value-added services and that other value added services may be presented to the consumer device 102.

In certain embodiments, the consumer application 110 may also be configured to determine, based at least in part on the account information, one or more consumer preferences associated with the merchant and/or merchant store location. To this end, the consumer application 110 may be configured to determine, based at least in part on the consumer preferences, a potential transaction event. The consumer application 110 may display the potential transaction event to the consumer 101. For example, the preferences may include, but is not limited to, notifying the consumer when a certain product of the merchant is discounted and/or become available. In one embodiment, the discount may be compared to a predetermined dollar amount threshold. For example, if the product of the merchant is below a certain dollar amount, the consumer 101 may be notified. In certain cases, the notification may provide the consumer 101 the option to purchase the product via the consumer application 110.

According to other embodiments, the systems and methods described herein may also enable one or more check-out transactions via the consumer application 110. In some implementations, the consumer application 110 may be configured to initiate a logout process upon determination that the consumer device 102 is located outside of a predetermined proximity to a merchant store location. In other implementations, the consumer application 110 may initiate a check-out process upon receiving instructions from the consumer 101, the service provider server(s) 120 and/or the merchant device(s) 156 to purchase one or more products and/or services from the merchant. As a result of the instructions, the consumer application 110 may provide an interface by which the consumer 101 may complete a purchase transaction for the products and/or services.

The one or more network and I/O interfaces 112 may include one or more communication interfaces or network interface devices to provide for the transfer of data between the consumer device 102 and another device (e.g., network server) via one or more networks, such as 118. The communication interfaces may include, but are not limited to: personal area networks (PANs), wired local area networks (LANs), wireless local area networks (WLANs), wireless wide area networks (WWANs), and so forth. The consumer device 102 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published Mar. 8, 2007; IEEE 802.11n-2009, published October 2009), or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the consumer device 102 and another device, such as an access point, a host computer, a server, a router, a reader device, and the like. The one or more networks 118 may include, but are not limited to, the Internet, a private network, a virtual private network, a wireless wide area network, a local area network, a metropolitan area network, a telephone network, and so forth.

The display 114 may include, but is not limited to, a liquid crystal display, a light-emitted diode display, or an E-Ink™ display as made by E Ink Corp. of Cambridge, Mass. The display 114 may be used to show content to a user in the form of text, images, or video. In certain instances, the display 114 may also operate as a touch screen display that may enable the user to initiate commands or operations by touching the screen using certain finger or hand gestures.

As previously discussed, one or more service provider server(s) 120 may also be in communication with the one or more network(s) 118, the consumer device 102, and/or merchant device(s) 156. The service provider server(s) 120 may also include a processor 122 and memory 124, which may store an operating system (0/S) 126, a database management system (DBMS) 128, and a login module 130. The service provider server(s) 120 may also include network and I/O interfaces 132, a display 134, and a storage 136. Storage 136 may provide non-transient storage of computer-executable instructions and other data and may include removable storage and/or non-removable storage including, but not limited to, magnetic storage, optical disk storage, and/or tape storage. The storage 136 may include storage that is internal and/or external to the service provider server(s) 120.

The DBMS 128 stored in memory 124 may be configured to support functionality for accessing, retrieving, storing, and/or manipulating data stored in external datastore(s) (e.g., service provider datastore(s) 134), data stored in the memory 124, and/or data stored in the data storage 136. For example, the DBMS 128 may be configured to retrieve and/or otherwise access loyalty account data associated with the consumer 101. The DBMS 128 may use any of a variety of database models (e.g., relational model, object model, etc.) and may support any of a variety of query languages.

The login module 130 may be a set of computer-executable instructions configured to receive login information from the consumer device 102 (e.g., via the consumer application 110). Based on the login information, the login module 130 may determine whether the consumer device 102 is authorized/authenticated to access account information associated with one or more consumer accounts, the merchant data and/or the merchant device. In certain embodiments, the login module 130 may receive, from the consumer device 102, a merchant identifier indicating that the consumer device 102 desires access to account information associated with a consumer account with the merchant based on the merchant identifier. For instance, the merchant identifier may be included as part of the login or access request. The merchant identifier may include a unique identification number or code associated with the merchant and/or the merchant location.

The login module 130 may provide the merchant identifier as well as a consumer identifier associated with the consumer 101 and/or the consumer device 102 to the account module 132. The account module 132 may be a set of computer-executable instructions configured to determine, based at least in part on the merchant identifier and/or the consumer identifier, account information associated with the consumer account with the merchant. For instance, the account information may be stored in the service provider datastore(s) 134. As such, the account module 132 may use the merchant identifier and the consumer identifier to access the corresponding account information in the service provider datastore(s) 134. Furthermore, one or more consumer preferences may be stored and/or otherwise associated with the account information. The account information and/or the consumer preferences may be provided to the consumer device 102 by the account module 132 and/or the merchant device 156. The consumer preferences may detail the types of value added services that may be provided to the consumer device 102 by the merchant device 156 based at least in part on the account information associated with the consumer.

In other implementations, the account information may be stored by one or more merchant device(s) 156. The account module 132 may identify the corresponding merchant server(s) 156 associated with the merchant identifier. The account module 132 may then transmit the consumer identifier to the merchant server(s) 156, which may be configured to determine the account information associated with the consumer account based on the consumer identifier. The account information may be transmitted back to the service provider server(s) 120, which may then be transmitted to the consumer device 102. In other embodiments, the merchant server(s) 156 may transmit the account information directly to the consumer device(s) 102. Further, the merchant device 156 may provide the consumer device 102 with one or more value added services.

As previously discussed, one or more merchant device(s) 156 may also be in communication with the network(s) 118. In general, the merchant devices 156 may refer to any type of electronic devices, and, more particularly, may refer to one or more of the following: servers, wireless communication devices, portable electronic devices, telephones (e.g., cellular phones, smart phones), computers (e.g., laptop computers, tablet computers), wearable computer devices, portable media players, personal digital assistants (PDAs), or any other electronic devices having networked capability. The merchant device(s) 156 may also include processor(s) 158 and memory 160, which may store an operating system (O/S) 162 and a merchant application 164. The merchant device(s) 156 may also include network and I/O interfaces 166 and a display 168.

In certain implementations, the merchant application 164 may be a set of computer-executable instructions configured to communicate with the service provider server(s) 120. For instance, as previously discussed, the merchant application 164 may receive a request for account information associated with a consumer identifier (e.g., from the service provider server(s) 120). The merchant application 164 may be configured to determine and/or otherwise access the account information based at least in part on the consumer identifier. The merchant application 164 may then be configured to transmit the account information back to the service provider server(s) 120 or directly to the consumer device 102.

According to one or more other embodiments, the merchant application 164 may also be configured to login to a merchant account (e.g., via the service provider server(s) 120) associated with the consumer 101 in order to render one or more services. For example, a pizza delivery driver for a pizza merchant could login to a merchant account associated with a consumer 101. Once the logged in, the merchant application 164 may be configured to receive payment for the pizza delivery.

Furthermore, the merchant device(s) 156 may be in communication with a payment processing device 170, either directly and/or via the network(s) 118. In certain implementations, the merchant application 164 may be configured to communicate with the payment processing device(s) 170 in order to facilitate one or more purchase transactions between the consumer 101 and a merchant associated with the merchant device(s) 156. To this end, the merchant application 164 may be configured to transmit and/or otherwise provide information associated with the one or more purchase transactions to the payment processing device 170.

In one or more embodiments, the merchant application 164 may check-in with a consumer device 102, which may be considered as a reverse check-in process. A reverse check-in process may be directed from the merchant device 156 to the consumer device 102. In this reverse check-in process, the merchant application 164 may be configured to deliver and confirm the merchant identity to the consumer 101 in order to perform additional services such as payment, notifications, receipts, etc. For example, a pizza delivery driver may use a merchant device 156, where the merchant application 164 may check-in to the consumer device 102 in order to receive payment or simply to deliver other services to the consumer device 102.

The payment processing device(s) 170 may be any electronic device capable of receiving payment information from a consumer 101, consumer device 102, merchant device 156, and/or any other devices. For instance, the payment processing device(s) 170 may be capable of receiving information via a magnetic strip on a card (e.g., a loyalty account card, a credit card, etc.) associated with the consumer 101. As another example, the payment processing device(s) 170 may also be configured to receive information via one or more NFC chips associated with the consumer 101. In yet other implementations, the payment processing device(s) 170 may receive payment information via manual entry.

The merchant radio beacon 172 may be a transmission-type device configured to periodically and/or continuously broadcast information associated with the merchant. Various types of wireless technology may be employed to broadcast such information, including, but not limited to, Bluetooth, Bluetooth Low-Energy, Wi-Fi, NFC, Radio Frequency Identification (RFID), infrared, Long-Term Evolution (LTE), and/or LTE-Advanced. As previously discussed, the broadcasted information may include, but is not limited to, a merchant identifier, location information (e.g., Global Positioning Satellite information, Wi-Fi Positioning System information, etc.), and/or any other type of information associated with the merchant. In certain embodiments, one or more merchant radio beacons 172 may be placed throughout a merchant location or retail store to periodically and/or continuously transmit the broadcasted information. The broadcasted information may be received by one or more consumer devices 102 that may utilize the broadcasted information in order to determine the consumer device 102 relative location to the merchant store location. Additionally, alternatively, the broadcast information associated with the merchant may be received by a service provider that may communicate that information to a consumer device attempting to access the one or more merchant data and/or one or more merchant devices 156.

According to one or more embodiments, the systems and methods described herein may enable secure communication of login information and other data between the consumer devices 102 and the merchant devices 156. For example, communication between the consumer device 102 and the merchant device may be transmitted using an encryption key shared between the consumer device 102 and the service provider server(s) 120. To this end, the encrypted data (e.g., encrypted data using the shared encryption key) may be passed from the consumer device 102, through the merchant device 156, and to service provider server(s) 120. Upon receipt of the encrypted data, the service provider server(s) 120 may be configured to decrypt the data. In certain embodiments, the merchant device 156 may not possess the shared encryption key to decrypt the data.

It will be appreciated that while the systems and methods described herein may be performed with respect to a merchant store location, other types of locations associated with a merchant are also contemplated. For instance, a merchant advertisement, such as a poster, billboard, and/or the like may also include and/or may be otherwise associated with a merchant radio beacon 172. Similarly, merchant products may also include and/or may be otherwise associated with a merchant radio beacon 172. Thus, the operations of the consumer application 110 described above may also be performed upon detection that the consumer device 102 is located within a predefined proximity to the merchant advertisements, merchant products, and/or any other items or location associated with the merchant. For example, in certain implementations, the consumer device 102 may include a vehicle infotainment system that detects that the vehicle is within a certain proximity to a merchant billboard (e.g., proximity to a merchant radio beacon 172 associated with the billboard). Based on this determination, the vehicle infotainment system may initiate a check-in process with the merchant and/or display certain information associated with the merchant and/or products or services associated with the merchant.

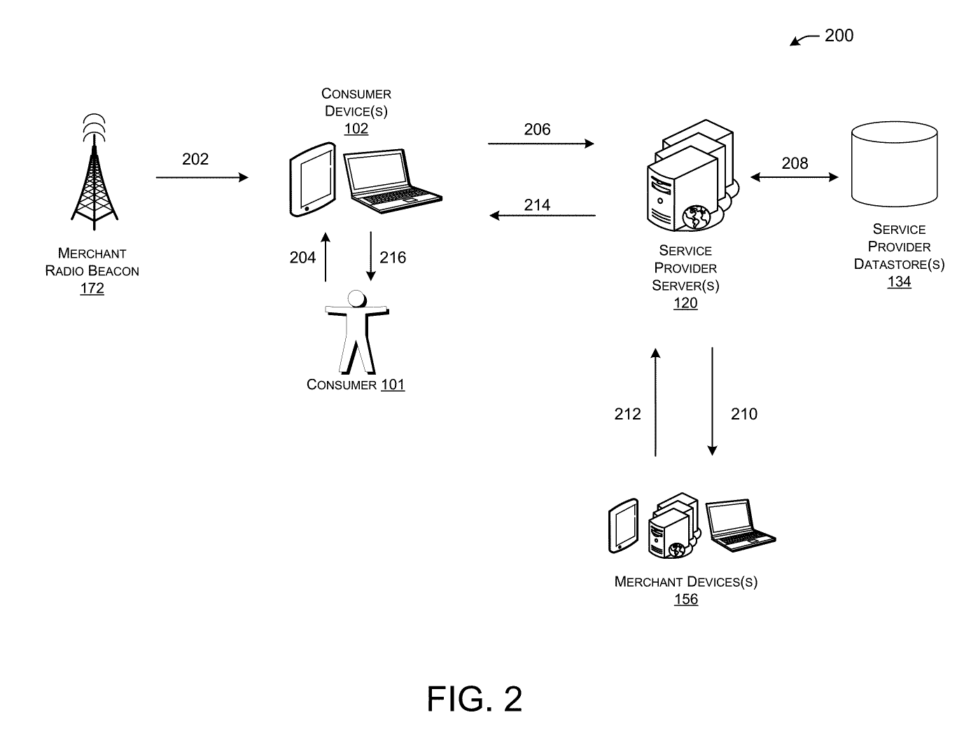

Referring now to FIG. 2, a diagram of an example data flow 200 is illustrated for managing account information in accordance with one or more example embodiments. This data flow 200 depicts a scenario where information broadcasted by the merchant radio beacon 172 is received by a consumer device 102 in order to initiate communication and/or transactions with a merchant device 156.

According to the data flow 200, a merchant radio beacon, such as 172 in FIG. 1, may be configured to broadcast 202 information associated with a merchant. The broadcasting may occur either periodically, continuously, at the occurrence of one or more events, or manually by a merchant. For example, the merchant may initiate a broadcast to interact with consumer devices 102 that are within a proximity of the merchant store. Further, the merchant radio beacon 172 may be configured to broadcast periodically such that every period information associated with the merchant is broadcasted to one or more consumer devices 102 that are proximate to a merchant device. Furthermore, the merchant radio beacon 172 may be configured to broadcast 202 information associated with the merchant whenever a sale is happening. In certain implementations, the broadcast information may include a merchant identifier although other types of information are also possible such as a store identifier, location information, and/or the like. A consumer device, such as 102 in FIG. 1, may be configured to receive the broadcast information (e.g., the merchant identifier).

In certain embodiments, upon receipt of the merchant identifier, the consumer device 102 may be configured to “wake-up” and/or launch a consumer application that may reside on the consumer device 102. Consumer device 102 may be an a monitoring state to receive such broadcast information before waking up. Additionally/alternatively, the consumer application may be configured to receive and/or retrieve the information associated with the consumer 101. For example, the consumer application 110 may be configured to receive 204 consumer information from the consumer 101. This information may be entered by the consumer 101 manually or automatically. Some example of consumer information that may be received by the consumer application may include, but not limited to, a consumer identifier, consumer login and/or password, a username, an email address, a payment device number or code, a consumer identification number or code, a phone number, a mobile device identification number or code, and the like. Alternatively, the consumer information may be already stored on the consumer device 102. In that case, the consumer application, which may reside on the consumer device 102, may be configured to automatically access the consumer information that may be stored on the consumer device 102. Upon determining the merchant identifier and the consumer information, the consumer device 102 may be configured to transmit 206 a login request to the service provider server(s) 120. The login request may include the merchant identifier and/or the consumer information.

According to one or more embodiments, the service provider server(s), such as 120 in FIG. 1 (e.g., via the login module 130) may be configured to determine, based at least in part on the merchant identifier and/or the consumer information, account information associated with a consumer account with the merchant. For instance, the account information may be stored in a service provider datastore 134. The service provider server(s) 120 may use the merchant identifier and/or consumer information to access 208 the corresponding account information of the consumer account in the service provider datastore(s) 134.

In other embodiments, the account information may be stored in one or more merchant device(s) 156. To this end, the service provider server(s) 120 may determine, based at least in part on the merchant identifier, one or more merchant devices(s) 156. As such, the service provider server(s) 120 may transmit 210 consumer information to the merchant device(s) 156. Upon receipt of the consumer information, the merchant device(s) 156 may determine the corresponding account information of the consumer account associated with the consumer information. The merchant device(s) 156 may then transmit 212 the account information to the service provider server(s) 120.

Upon receipt of the account information (e.g., via access of the service provider datastore 134 and/or from the merchant device(s) 156), the service provider server(s) 120 may be configured to transmit 214 and/or otherwise provide the account information back to the consumer device(s) 102. The consumer device(s) 102 may then be configured to display the account information to the consumer 101.

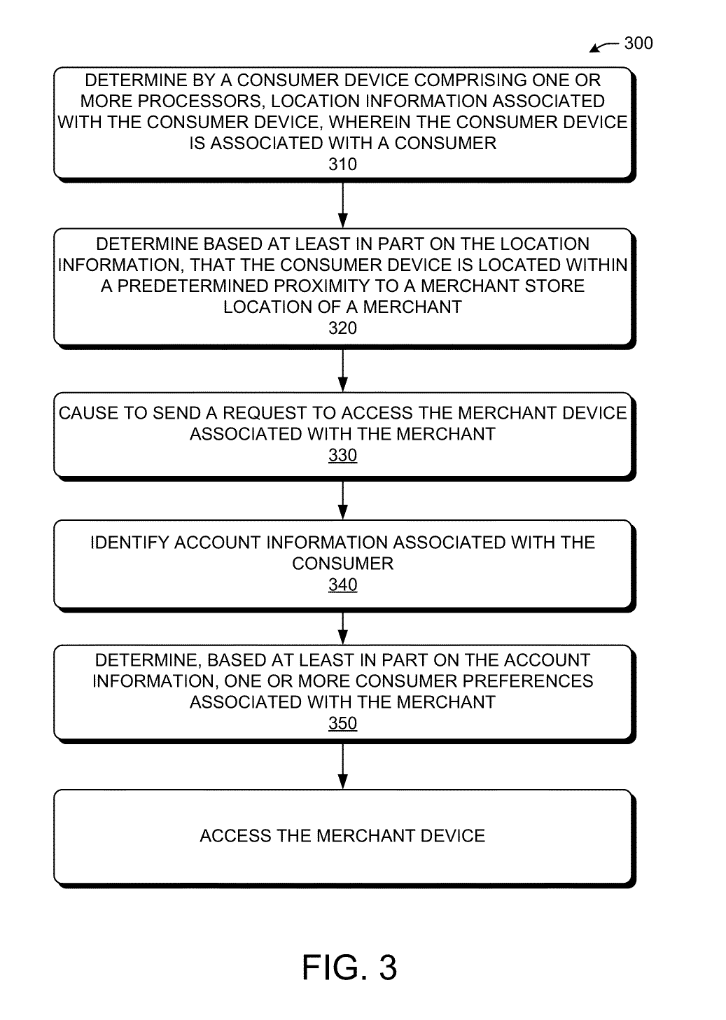

Turning now to FIG. 3, a flow diagram of an example method 300 for managing account information is illustrated in accordance with one or more example embodiments.

The method may include block 310, in which a device, such as a consumer device, such as 102 in FIG. 1 may determine location information associated with the consumer device 102. For example, the consumer device 102 may transmit its location to one or more networks, including a network associated with a merchant location. The consumer device when the two may transmit periodically or continuously, the location information such as one or more merchant devices may be aware of the consumer device location.

At block 320, the consumer device 102 may determine, based at least in part on the location information associated with the consumer device, that the consumer device 102 is located within a predetermined or predefined proximity to a merchant store location of a merchant. For example, in order to access a merchant device and/or merchant data associated with the merchant, the consumer device 102 may check-in with the merchant device at a merchant store location or remotely. A consumer device may be able to establish a connection with a merchant device without being in the proximity of the merchant device. For example, a consumer device may be able to access a merchant device through a network or through other devices, such as service provider servers 120. The predetermined or predefined proximity to the merchant store location may be determined based on whether the consumer device 102 is within the perimeters of, for example, geo-fencing and micro location that may be based on wireless technologies. The geo-fencing may be a perimeter of geographic areas, such as a radius around the merchant store and the micro location technology may determine indoor positioning of one or more objects or people inside a building. Using such technologies, it may be determined that the consumer device 102 is located within a proximity of the merchant store location.

At block 330, the consumer device 102 may transmit, to a service provider server, such as 120 in FIG. 1, a request to a merchant device, such as 156 in FIG. 1. Consumer device 102 may communicate with service provider server 120 and/or one or more merchant devices 156, which may be located in the merchant store or located remote to the merchant store. The service provider server 120 may interact with the consumer device 102 to provide the consumer device 102 with services such as authentication, verification and/or access merchant data and/or access to the one or more merchant devices 156. The merchant data may determine how the merchant requires further interaction with the consumer device.

At block 340, the consumer device 102 may receive, from the service provider server 120, account information associated with a consumer account with the merchant. For example, the service provider server 120 may retrieve account information associated with the consumer account and may utilize that information to provide the consumer device 102 with additional services such as authentication, verification and/or access merchant data and/or access to the one or more merchant devices 156 based on the account information.

At block 350, the consumer device 102 may determine, based at least in part on the account information, one or more consumer preferences associated with the merchant. The merchant may associate one or more consumer preferences with a certain consumer based on the account information of the consumer. For example, the merchant may offer a variety of value added services such as but not limited to, offers, coupons, loyalty deals, etc. These value added services may vary based on the consumer and the account information.

At block 360, the consumer device 102 may have access to the merchant device, such that the access allows the consumer device 102 and the merchant device 156 to communicate in order to complete one or more transactions and/or to exchange information, notifications, receipts, promotions, etc. The access may also allow the consumer device 1022 receive merchant data that may determine how the merchant requires further interaction with the consumer device. For example, after a consumer device 102 checks in with a merchant device 156, one or more post check-in events may be initiated by the consumer device 102 and/or the merchant device 156. One example of post check-in events may include a check-out event, where the merchant device may provide the consumer device 102 with a summary of a transaction, a notification of value added services, deals related to consumer preferences, etc. It is understood that the above are only examples, and not meant to be limitations.

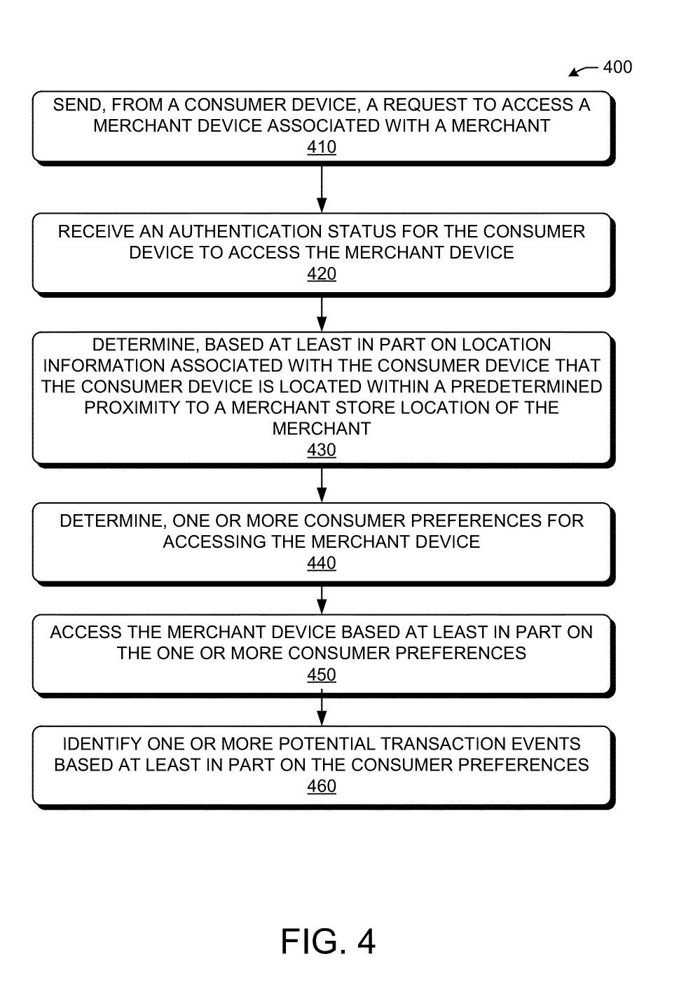

Turning now to FIG. 4, a flow diagram of an example method 400 for managing account information is illustrated according to one or more example embodiments.

The method 400 illustrates a scenario where an automated check-in process may occur based on consumer preferences. The check-in process may be automated without the consumer taking a specific action.

At block 410, a consumer device 102 may send a request to access merchant data and/or a merchant device associated with a merchant. The request may be sent by the consumer device 102 to a service provider server 120 and/or a merchant device 156. In one embodiment, the request may include at least in part a consumer identifier associated with the consumer and/or a merchant identifier associated with the merchant.

At block 420, the service provider server 120 may determine, based at least in part on the merchant identifier and the consumer identifier, account information associated with a consumer account with the merchant or whether the consumer device 102 is authorized to access the merchant device 156. Consequently, the service provider server 120 may send the consumer device 102, the authentication status to allow access to the account information associated with a consumer account with the merchant and/or the merchant device. In case the service provider server 120 determines that the consumer device 102 is not authorized to access the merchant data and/or the merchant device, the service provider server 120 may send a failure response to the consumer device 102.

At block 430, the consumer device 102 may determine its location to be within a predetermined proximity to a merchant store location of the merchant. For example, the location of the consumer device 102 may be determined relative to the location of the merchant store location based on geo-fencing and/or micro location technologies.

At block 440, the consumer device 102 may determine one or more consumer preferences for accessing the merchant device and/or the merchant data. For example, consumer preferences, may dictate whether a check-in may occur based on certain conditions such as being located within a perimeter of a geo-fencing system and/or utilizing micro location technologies to determine the location of the consumer device.

At block 450, the consumer device 102 may access the merchant data and/or the merchant device based at least in part on the consumer preferences. For example, if one or more of the above conditions are met (e.g., being within a certain perimeter), and automated check-in events may cause, for example, an application on consumer device 102 to wake up and perform the check-in with the merchant device. When the application wakes up, it may exchange data with the merchant device and/or service provider in order to establish a connection with the merchant device. After the check-in process, one or more transaction may occur. For example, a consumer may place an order with the merchant and may receive received for completing the transaction, or may receive one or more value added services.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A method comprising:
determining, by a consumer device comprising one or more processors, location information associated with the consumer device, wherein the consumer device is associated with a consumer;
determining, by the consumer device, based at least in part on the location information, that the consumer device is located within a predetermined proximity to a merchant store location of a merchant;
causing to send, by the consumer device, a request to access a merchant device associated with the merchant;
identifying, by the consumer device, account information associated with the merchant;
determining, by the consumer device, based at least in part on the account information, one or more consumer preferences associated with the merchant; and
accessing, by the consumer device, the merchant device based at least in part on the one or more consumer preferences.

2. The method of claim 1, wherein determining the location information comprises at least one of:
identifying wireless radio information from a wireless device associated with the merchant store location, and
determining Global Positioning Satellite (GPS) information associated with the consumer device and the merchant store location.

3. The method of claim 2, wherein the wireless radio information comprises at least one of Bluetooth information, Bluetooth Low-Energy information, Near-Field Communication information, Radio Frequency Identification information, Wi-Fi information, or ad-hoc network information.

4. The method of claim 1, wherein the account information comprises at least one of loyalty account information, order history information, notification information, receipt information, advertisement information, payment information, or product offer information.

5. The method of claim 1, wherein causing to send the request to access the merchant device further comprises:
causing to send a consumer identifier associated with the consumer device and a merchant identifier associated with the merchant store location.

6. The method of claim 5, wherein the merchant identifier is received from a wireless device associated with the merchant store location.

7. The method of claim 5, wherein the merchant identifier is determined by scanning optical machine-readable data associated with the merchant store location.

8. The method of claim 5, wherein the merchant identifier comprises a unique identification number or code associated with the merchant or merchant store location.

9. The method of claim 1, further comprising:
identifying, based at least in part on the one or more consumer preferences, a potential transaction event occurring after accessing the merchant device; and
displaying the potential transaction event to the consumer.

10. A system comprising:
at least one processor; and
at least one memory comprising computer-executable instructions, that when executed by the at least one processor, causes the at least one processor to:
send, from a consumer device, a request to access a merchant device associated with a merchant;
receive an authentication status for the consumer device to access the merchant device;
determine, based at least in part on location information associated with the consumer device that the consumer device is located within a predetermined proximity to a merchant store location of the merchant;
determine, one or more consumer preferences for accessing the merchant device;
access the merchant device based at least in part on the one or more consumer preferences; and
identify one or more potential transaction events based at least in part on the consumer preferences.

11. The system of claim 10, wherein the request includes at least one of a merchant identifier and a consumer identifier.

12. The system of claim 11, wherein the computer-executable instructions further cause the at least one processor to:
determine, based at least in part on the merchant identifier and the consumer identifier, account information associated with the consumer;
determine, based at least in part on the account information, the one or more consumer preferences.

13. The system of claim 11, wherein the computer-executable instructions further cause the at least one processor to:
determine, based at least in part on the merchant identifier, location information associated with the consumer device.

14. The system of claim 11, wherein the consumer identifier comprises at least one of a username, an email address, a payment device number, a consumer identification number, a phone number, and a mobile device identification number.

15. A non-transitory computer-readable medium storing computer-executable instructions, that when executed by one or more processors, cause the one or more processors to:
determine location information associated with a consumer device;
determine based at least in part on the location information, that the consumer device is located within a predetermined proximity to a merchant store location of a merchant;
causing to send a request to access the merchant device associated with the merchant;
identify account information associated with the merchant;
determine, based at least in part on the account information, one or more consumer preferences associated with the merchant; and
access the merchant device based at least in part on the one or more consumer preferences.

16. The computer-readable medium of claim 15, wherein the computer-executable instructions to determine the location information further comprise instructions to:
identify wireless radio information from a wireless device associated with the merchant store location, or
determine Global Positioning Satellite (GPS) information associated with the consumer device and the merchant store location.

17. The computer-readable medium of claim 15, wherein the wireless radio information comprises at least one of Bluetooth information, Bluetooth Low-Energy information, Near-Field Communication information, Radio Frequency Identification information, Wi-Fi information, and ad-hoc network information.

18. The computer-readable medium of claim 15, wherein the account information comprises at least one of loyalty account information, order history information, notification information, receipt information, advertisement information, payment information, and product offer information.

19. The computer-readable medium of claim 15, wherein the computer-executable instructions to cause to send the request to access the merchant device further comprise instructions to cause to send a consumer identifier associated with the consumer device and a merchant identifier associated with the merchant store location.

20. The computer-readable medium of claim 15, wherein the merchant identifier is received from a wireless device associated with the merchant store location.
